(19) United States
(12) Patent Application Publication
(10) Pub. No.: US 2015/0371208 A1
(43) Pub. Date: Dec. 24, 2015

(54) METHOD AND SYSTEM FOR MICRO-ACCUMULATION OF FUNDS

(71) Applicant: King Hei Sin, Hong Kong (HK)

(72) Inventors: Vanessa Liping Fan, Richmond (CA); King Hei Sin, Hong Kong (HK)

(21) Appl. No.: 14/310,087

(22) Filed: Jun. 20, 2014

(51) Int. Cl. G06Q 20/22; G06Q 20/10

(52) U.S. Cl. CPC G06Q 20/29; G06Q 20/10

(57) ABSTRACT

The present invention includes a method embodiment for accumulation and dispensation of micro-accumulation funds. The method includes performing, by a micro-accumulation fund (“MAF”) system, the system including a user interface device, a data storage device, and a processor, the steps of: receiving point-of-sale information relating to a purchase made by a user; computing a round-off amount in accordance with a user-defined rounding value; and transferring the round-off amount to a holding account. The present invention is further directed toward embodiments including a system and a computer program stored on a non-transitory computer-readable medium.

### BACKGROUND OF THE INVENTION

1. Field of the Invention

The present invention is directed toward a method and system for micro-accumulation and distribution of funds.

2. Description of the Related Art

Financial products, including credit cards, stored value cards, debit cards, and automated teller machine (“ATM”) cards, have long been popular products of paying for goods and services, both for physical, brick-and-mortar locations and virtual merchants. Thus, such products can be considered ubiquitous forms of payment. Similarly, many users of these financial products currently engage in endeavors such as donations to charity, financial investing, and accruing funds in various types of savings accounts. In addition, many more users of such financial products may have an interest in these sorts of endeavors, but neglect to do so due to the inconvenience of managing transfers to these accounts or to the mistaken belief that large sums are required when effecting a transfer.

Accordingly, it would be beneficial to provide a method relating to purchases made using e.g. the aforementioned financial products that facilitates the transfer of funds for distribution into various endeavors, such as investment, charity and savings. Such a method may provide for an extra user-defined amount to be automatically added based on a purchase amount, and subsequently transferred to a holding account. Alternatively, this extra amount may represent an additional, separate transaction charge. This extra amount may accrue across multiple purchases before being transferred, e.g. in bulk, to a desired destination such as charity, investment, savings, etc. Furthermore, it would be beneficial if the method were operable on a computer system accessible by a user via the internet.

### SUMMARY OF THE INVENTION

The present invention is directed toward a method for accumulation and disbursement of micro-accumulation funds. In at least one embodiment, the method comprises the performance of steps by a micro-accumulation fund system (“MAF system”). The MAF system may comprise a user interface device, a data storage device, and a processor. The steps may include receiving point-of-sale information relating to a purchase made by a user; computing a round-off amount in accordance with a user-defined rounding value; and transferring the round-off amount to a holding account. The point-of-sale information comprises a purchase amount.

Furthermore, in at least one embodiment, computing a round-off amount comprises calculating a value X that is a lowest multiple of the user-defined rounding value such that X is greater than or equal to the purchase amount. Computing a round-off amount also comprises subtracting the purchase amount from X to yield the round-off amount.

Round-off amounts may be transferred to a holding account, where they may accumulate until transferred to a user's chosen destination. Examples of destinations include but are not limited to charity accounts, investment accounts, betting-investment accounts (such as for use with betting-related activities), bank accounts, as well as for withdrawal for an individual beneficiary, transfer to an account located overseas or in a local financial institution, transfer/storage in an individual's financial product such as a credit card, stored value card etc., disbursement in the form of currency, including crypto-currency, or for use in subsequent purchases including for virtual checkout services. Transfers to a destination may be accomplished upon a user-initiated event, i.e. upon some action taken on the part of the user, or may be done pursuant to an automatic or regularly occurring, user-defined schedule, such as on a particular date of the month, day of the week, etc.

The present invention may also be directed toward system embodiments and/or embodiments including computer program segments stored on non-transitory computer readable media.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of a MAF system according to an embodiment of the present invention.

FIG. 2 is a schematic representation of a fund management system according to an embodiment of the present invention.

FIG. 3 is a schematic representation of a method according to an embodiment of the present invention.

FIG. 4 is a schematic representation of a method of calculating a round-off amount in relation to a rounding value and a transaction amount in accordance with an embodiment of the present invention.

Like reference numerals refer to like parts throughout the several views of the drawings.

### DETAILED DESCRIPTION OF THE PREFERRED EMBODIMENT

As represented in the accompanying drawings, the present invention is generally directed to a method and system for micro-accumulation of funds. Generally speaking, users of the present invention may include individual persons, companies, and associations.

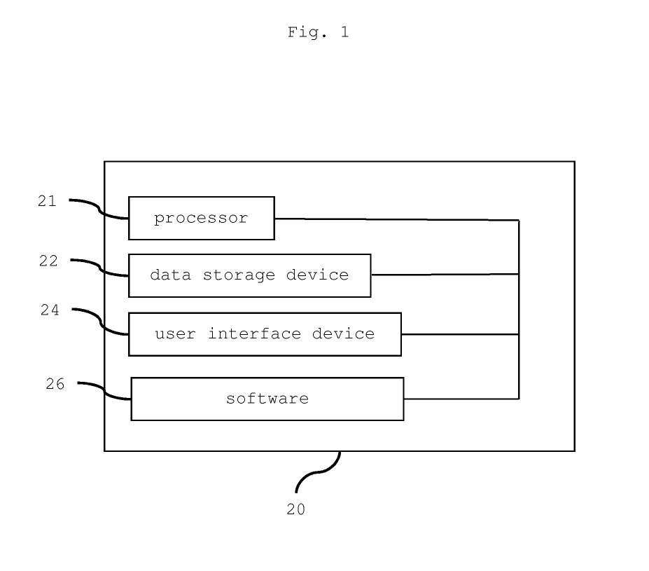

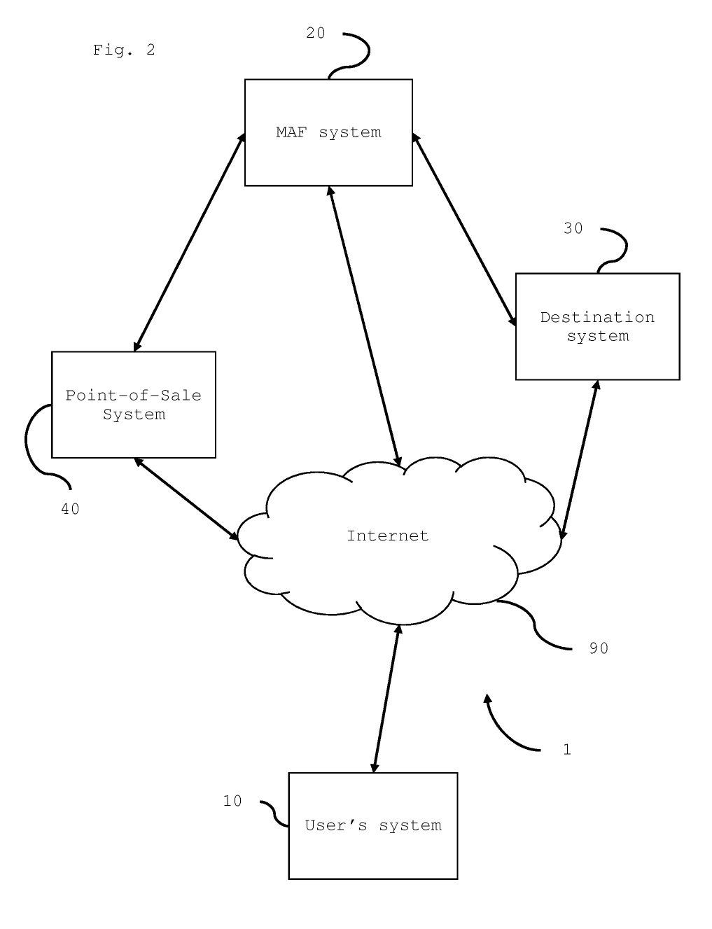

With primary reference to FIG. 2, a method embodiment of the present invention (which will be discussed in detail below) is operable on a fund management system, an example of which is generally indicated as 1. The fund management system 1 in at least one embodiment comprises a micro-accumulation fund system (hereinafter “MAF system”) 20. With reference to FIG. 1, The MAF system 20 may comprise a computer server, including a user interface device 24, processor 21, and data storage device 22, as well as software 26 operable thereon. The software 26 may comprise computer programming segments written in any suitable programming language, including for presentation and or execution by the MAF system 20 and/or a user's system 10. The MAF server may also comprise the necessary hardware and/or software to provide for interconnectivity with the user's system, such as via the internet utilizing applicable protocols.

The user's system 10 may be a device employed by user to interact with the MAF system 20 and its features, as are also discussed below. Examples of user's systems 10 include any suitable web-accessible devices. In at least one embodiment, users may interact with the MAF system 20 by way of a website accessible by and displayed upon a user's system 10, such as through a web browser or other application, such as a mobile application.

In addition, the fund management system 1 may comprise a destination system 30, such as a third-party server. The destination system 30 may be a computer server, and includes but is not limited to any system as may be suitable for use by a financial institution. The MAF system 20 and the destination system 30 may be in direct communication or may be in communication through a network, such as the internet 90.

Further, the fund management system 1 in at least one embodiment comprises a point-of-sale system 40. The point-of-sale system 40 provides to the MAF system 20 information relating to a user's purchases, as is further discussed below. The point-of-sale system 40 may comprise retailers of goods and services and/or a credit/debit card transaction processing system, card-reader hardware, a user's financial institution's system, etc. Thus, the point-of-sale system 40 may comprise computer systems, networks, etc. The MAF system 20 may communicate directly with the point-of-sale system 40 and/or the two may communicate through a network, such as the internet 90. Accordingly, the point-of-sale system 40 may also broadly include transaction processing systems related to processing of credit cards, debit cards, automated teller machine (“ATM”) cards, and/or stored-value cards, etc. as well as banking systems facilitating such financial products.

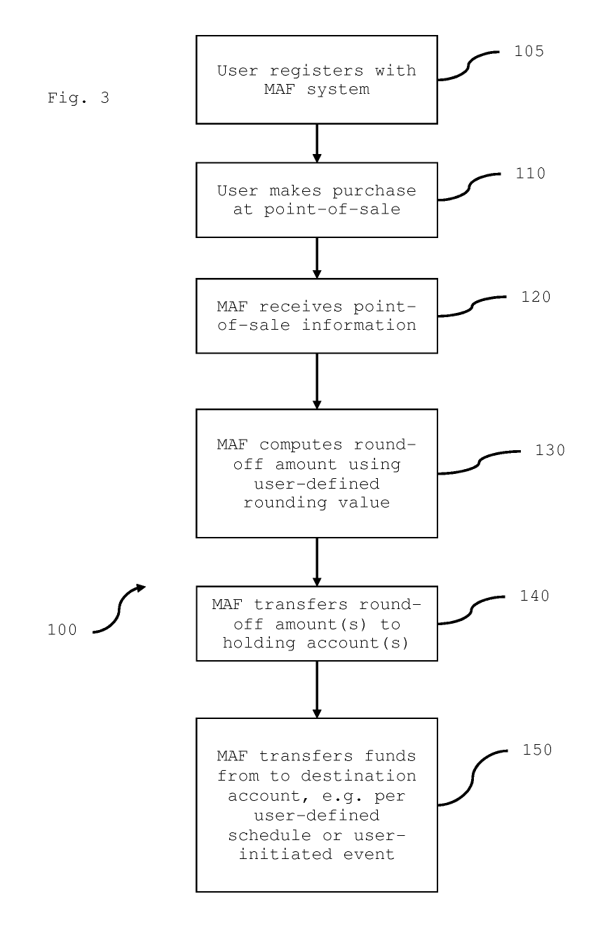

Turning now to FIG. 3, an example embodiment of a method 100 of the present invention is provided. A user may register with the MAF system, as indicated at 105. Such registration may include providing, by the user to the MAF system, of a user name, password, and financial information. Financial information may include, for example, information pertaining to an individual's financial product, such as a credit, debit, ATM card, and/or stored-value card. Financial information may further include information pertaining to a user's financial accounts, such as a user's login name and password for a financial institution's website. Such financial information may be provided to facilitate withdrawal and deposit of funds according to operation of various steps of the method as discussed below.

In at least one embodiment, a user may then make a purchase at a point-of-sale, as indicated at 110. A point-of-sale may include any place, whether physical or virtual, where a user may make a purchase, such as brick-and-mortar as well as online retailers of goods and services.

In at least one embodiment, following the user's purchase, the MAF system receives point-of-sale information, as indicated at 120. The MAF system receives payment information from the point-of-sale system, which may include the physical and/or virtual seller of a good or service as well as the attendant payment processing system(s). The MAF system in at least one embodiment comprises card-reader hardware to facilitate the MAF system's acquiring of point-of-sale information. The payment information includes, at a minimum, a purchase amount.

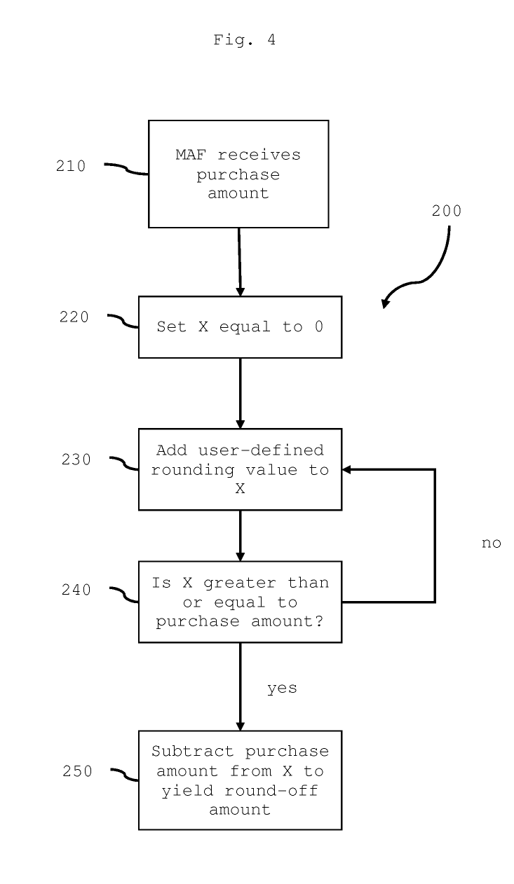

In at least one embodiment, the MAF system computes a “round-off” amount in accordance with a user-defined “rounding value,” as indicated at 130. The relatedness of the round-off and rounding value may be clarified with reference to FIG. 4, which depicts one embodiment of a method 200 of calculating a round-off amount in accordance with a rounding value. A round-off amount refers to an amount in addition to the total purchase amount to be charged to the user's account or registered financial product, e.g. a credit card, debit card, ATM card, and/or stored value card, for a particular good and/or service. This additional round-off amount is determined in conjunction with a user-defined rounding value. In at least one embodiment, the round off amount is a separate transaction charged to the user's account distinct but correlating to the transaction representing the charge for the total purchase amount for a particular good and/or service. Accordingly, the user's account will reflect two transactions in such an embodiment.

A rounding value, including but not limited to $1.00, $2.00, $5.00, and $10.00, may be selected from a list of pre-determined options presented to a user, or may be determined by the user, such as by typing a numerical value in a text box, such as when interacting with the MAF system 20 through a web-based interface. In at least one embodiment, the user may enter, such as into a text box, and/or select a rounding value, such as from an array of predetermined options, that is to be automatically applied to future purchases. In other embodiments, the user may select a rounding amount on a per-purchase basis, allowing for each purchase to be potentially calculated in conjunction with a different rounding amount. The role of a rounding value in various embodiments of the present invention will be discussed below. Briefly, however, a rounding value is at least partially determinative of an amount that is to be added to a user's total purchase and subsequently transferred to the user's holding account. Alternatively, in at least one embodiment separate transactions are made: one for the total amount and one for the rounding value.

With reference to FIG. 4, an embodiment of a method 200 of calculating a round-off amount in accordance with a rounding value is provided. A purchase amount is received by the MAF system, as at 210, and an arbitrary variable X is initialized as equal to 0, as at 220. The user-defined rounding value is then repeatedly added to X until X is greater than or equal to the purchase amount, as indicated at 230 and 240. Accordingly, by way of repetitive addition, X is now a “multiple” of the rounding value. When X is greater than or equal to the purchase amount, the purchase amount is subtracted from X. X is now equal to the round-off amount, as at 250.

To provide a numerical example of the above method 200, a purchase amount of $11.50 and a rounding value of $5.00 is considered. X is set to 0. Then $5.00 (the rounding value) is added to X. Since X equals $5.00 and is less than $11.50, $5.00 (the rounding value) is again added to X. Since X equals $10.00 and is still less than $11.50, $5.00 (the rounding value) is again added to X. Now, X=$15.00, which is the lowest multiple of the rounding value, $5.00, that is greater than or equal to the purchase amount, $11.50. Having calculated X, the MAF system now subtracts the purchase amount of $11.50 from X. Subtracting $11.50 from $15.00 yields a round-off amount of $3.50.

The foregoing method of computing a round-off amount is but one example for illustrative purposes, and it should thus be appreciated that other embodiments of the present invention may implement alternative methods.

Returning to FIG. 3, the method 100 in at least one embodiment comprises transferring the round-off amount to a holding account 140. The holding account may be operated on or by the MAF system. Examples of holding accounts include but are not limited to trust accounts and escrow accounts.

In at least one embodiment, funds in the holding account accumulate until they are transferred to a destination account 150. Destination accounts, managed and/or located on destination systems, are selected by the user as the chosen destination for a transfer of at least some portion of the user's funds in the holding account. Examples of destination accounts may include charities, investment accounts, and a user's bank account. A further example includes betting-investment accounts, including those managed by a betting portfolio manager, who may be tasked with monitoring bets across various sports, venues, locales, etc. transfer may occur as a one-time, user-initiated event, such as a user's selection to initiate an immediate transfer or a transfer on a predetermined date and/or time. The transfer may also be set by the user to recur automatically according to a pre-determined schedule, such as weekly, monthly, every Monday, the last day of every month, etc. Further, in at least one embodiment, a user may select multiple predetermined transfers. Further, in at least one embodiment, a user may withdraw funds from the holding account, such as in the form of currency or crypto-currency such as BitCoin or LiteCoin. In an alternative embodiment, a user may use funds in the holding account as a means of paying when interacting with virtual payment processors, such as Google Checkout or Paypal. A user may also withdraw funds for an individual beneficiary, transfer to an account located overseas or in a local financial institution, transfer/storage in an individual's financial product such as a credit card, ATM card, stored value card etc.

Furthermore, and with reference again to FIG. 2, in at least one embodiment the MAF system 20 may be configured to transfer an amount from a point-of-sale system 40 to a holding account associated with the MAF system 20, such as funds from a user's card to the holding account. This may be applicable in such case where a point-of-sale system 40 is a bank account, credit card, or other financial product such as those previously described. The MAF system 20 causes the user's account associated with the point-of-sale system 40 to be charged, debited, withdrawn etc. a “direct transfer” amount, which is then deposited in the user's holding account associated with the MAF system 20. This “direct transfer” may be initiated upon a user's prompting, or may be set to occur according to a user-defined schedule, such as on a particular date of the month, day of the week, etc. After accruing in the holding account of the MAF system 20, the “direct transfer” funds may be transferred to an account associated with a destination system 30 and/or withdrawn in accordance with the foregoing description.

The present invention may also be directed to an embodiment in the form of a computer program for carrying out the various steps of the method 100 of the accompanying figures. Accordingly, the computer program may comprise at least one code segment directed to at least one embodiment of the present invention. As used herein, “code segment” in the singular and “code segments” in the plural are interchangeable. The at least one code segment defines instructions for operation by a processor of a computer, causing the processor to practice a method embodiment of the present invention. Thus, the computer program may be stored on a non-transitory computer readable medium for execution by a computer system, such as by at least one processor thereof. Thus, the computer program may be deployed on a disk, memory device, etc. and may be coded thereon in any suitable programming language or languages for installation and/or operation by any suitable computer system and associated operating system or systems as required.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for accumulation and disbursement of micro-accumulation funds, the method comprising:
performing, by a micro-accumulation fund (“MAF”) system, the system comprising a user interface device, a data storage device, and a processor, the steps of:
receiving point-of-sale information relating to a purchase made by a user;
computing a round-off amount in accordance with a user-defined rounding value; and
transferring the round-off amount to a holding account.

2. The method of claim 1 further comprising transferring, by the MAF system, the round-off amount to a holding account, the round-off amount being added to the contents of the holding account.

3. The method of claim 2 further comprising transferring, by the MAF system, at least a portion of the contents of the holding account from the holding account to a destination account.

4. The method of claim 3 wherein the destination account comprises an investment account.

5. The method of claim 3 wherein the destination account comprises a user's registered financial product.

6. The method of claim 3 wherein the destination account comprises a charity account.

7. The method of claim 3 wherein the destination account comprises a user's bank account.

8. The method of claim 3 wherein the destination account comprises a betting-investment account.

9. The method of claim 3 comprising transferring the round-off amount upon an occurrence of a user initiated event.

10. The method of claim 2 comprising transferring the round-off automatically according to a user-defined schedule.

11. The method of claim 10 wherein the user-defined schedule is weekly.

12. The method of claim 10 wherein the user-defined schedule is monthly.

13. The method of claim 1 further comprising transferring, by the MAF system, a direct transfer amount to a holding account, the direct transfer amount being added to the contents of the holding account.

14. The method of claim 1 wherein:
the point-of-sale information comprises a purchase amount; and
computing a round-off amount comprises:
calculating a value X that is a lowest multiple of the user-defined rounding value such that X is greater than or equal to the purchase amount; and
subtracting the purchase amount from X to yield the round-off amount.

15. The method of claim 14 wherein the user-defined rounding value is within the range of $1.00-$2.00, inclusively.

16. The method of claim 14 wherein the user-defined rounding value is within the range of $2.00-$5.00, inclusively.

17. The method of claim 14 wherein the user-defined rounding value is within the range of $5.00-$10.00, inclusively.

18. The method of claim 14 wherein the user-defined rounding value is within the range of $10.00-$15.00, inclusively.

19. A computer system for accumulation and disbursement of micro-accumulation funds, the system comprising:
a component for receiving point-of-sale information relating to a purchase made by a user;
a component for computing a round-off amount in accordance with a user-defined rounding value; and
a component for transferring the round-off amount to a holding account.

20. A non-transitory computer readable medium containing program instructions for accumulation and dispensation of micro-accumulation funds, wherein execution of the program instructions by at least one processor of a computer system causes the at least one processor to carry out the steps of:
receiving point-of-sale information relating to a purchase made by a user;
computing a round-off amount in accordance with a user-defined rounding value; and
transferring the round-off amount to a holding account.
